(19) United States
(12) Patent Application Publication
(10) Pub. No.: US 2012/0109518 A1
(43) Pub. Date: May 3, 2012

(54) GLOBAL POSITIONING SYSTEM PEDOMETER

(75) Inventor: XI-MEI HUANG, Shanghai (CN)

(73) Assignees: INVENTEC APPLIANCES (SHANGHAI) CO. LTD., Shanghai (CN); INVENTEC APPLIANCES (NANCHANG) CO. LTD., Nanchang (CN); INVENTEC APPLIANCES CORP., NEW TAIPEI (TW)

(21) Appl. No.: 13/189,346

(22) Filed: Jul. 22, 2011

(30) Foreign Application Priority Data
Nov. 2, 2010 (CN) 201010526690.6

(51) Int. Cl. G01C 21/00

(52) U.S. Cl. 701/433; 701/439

(57) ABSTRACT

A global positioning system pedometer assists and guides users to plan an appropriate exercise path and control their exercise conditions, comprising a mode setting unit, a path generating unit, a processing unit, a display unit and a sensing unit installed in the processing unit. Wherein, the path generating unit generates an exercise path based on an exercise mode set by the mode setting unit, a start location and an end location and calculates a total distance of the exercise path. The total number of steps of a user's exercise is calculated through the sensing unit, and the processing unit calculates calorie consumption based on the total number of steps and the set exercise mode to generate nutrition supplement information. The display interface displays the total number of steps, calorie consumption and required nutrition supplement information for the users to control their exercise and avoid insufficient or excessive exercise.

### BACKGROUND OF THE INVENTION

1. Field of the Invention

The present invention relates to a global positioning system pedometer, particularly to a pedometer capable of providing an appropriate exercise path to a user and related information of user's exercise conditions.

2. Brief Description of the Related Art

As the concept of body maintenance rises in recent years, people pay increasingly more attentions to exercise, in addition to having health food. To achieve the effect of exercise, we can do various different exercises such as swimming, playing balls, walking, jogging, or bicycling. Among these exercises, walking, jogging and bicycling are not limited by time or space, and almost cost no additional expense, and thus they become favorable fitness exercises.

However, it is relatively difficult to control the level of exercise appropriately when we walk, jog or ride a bicycle, thus resulting in insufficient exercise for the expected fitness effect or over-exercise to impose a heavy load to our muscles or body. Although various different models of pedometers are available in the market, the way of learning one's conditions of walking, jogging or bicycling through the number of steps or controlling one's amount of exercise by the number of steps fails to provide objective or accurate information, since we are unable to know whether or not the level of our exercise and the required nutrients we should take accordingly are enough through the total number of steps. When we do our exercise including walking, jogging, or bicycling, we usually select our familiar route, and the exercise will become boring very soon. Furthermore, we cannot know how far we have walked, jogged or ridden. As a result, muscle strains often happen due to the over-exercise.

To overcome the aforementioned problem, there is an urgent need for a pedometer capable of providing an exercise path to a user based on a start location, an end location, an exercise mode and an exercise requirement set by the user, as well as transmitting the total number of steps, the total calorie consumption, and the corresponding nutrition supplement information during the exercise process to the user to let the user know about the overall exercise conditions.

### SUMMARY OF THE INVENTION

In view of the drawbacks of the prior art, it is a primary objective of the present invention to provide a global positioning system pedometer capable of providing an appropriate exercise path to a user and related information of the user's exercise conditions to overcome the user's problem of unable to control the appropriate amount of exercise accurately.

To achieve the foregoing objective, the present invention provides a global positioning system pedometer, comprising a mode setting unit, a path generating unit, a processing unit and a display unit. The processing unit comprises a sensing unit. The mode setting unit is provided for inputting an exercise mode, and the path generating unit is provided for generating an exercise path based on a start location, an end location and an exercise mode inputted from the mode setting unit, and for calculating the total distance of the exercise path. The processing unit is coupled to the mode setting unit and the path generating unit for receiving and transmitting the exercise mode to the path generating unit. The sensing unit senses the user's exercise steps to obtain a total number of steps, and then the processing unit calculates calorie consumption based on the total number of steps and the exercise mode, and generates nutrition supplement information corresponding to the calorie consumption. The display unit is coupled to the processing unit for receiving and displaying the exercise path, the total number of steps, the calorie consumption and the nutrition supplement information.

Preferably, the global positioning system pedometer further comprises a positioning unit for obtaining a current location and taking the current location as the start location.

Preferably, the global positioning system pedometer further comprises a transmission interface unit for connecting to an external electronic device, and the global positioning system pedometer transmits exercise data to the external electronic device through the transmission interface unit.

Preferably, the start location and the end location are situated at the same location.

Preferably, the exercise mode is walking, jogging, running or bicycling.

Preferably, the global positioning system pedometer further comprises a requirement unit coupled to the processing unit, for recording exercise requirement information including predetermined calorie to-be-consumed or predetermined weight to-be-reduced; and the evaluation unit coupled to the processing unit, for providing a suggested exercise distance based on the exercise requirement information and the exercise mode.

Preferably, the path generating module further generates the exercise path matched with the suggested exercise distance based on the suggested exercise distance, the start location, the end location and the exercise mode.

In summation, the global positioning system pedometer of the present invention includes one or more following advantages.

(1) The global positioning system pedometer provides an appropriate exercise path to a user according to the start location, end location and selected exercise mode set by the user, and displays the related exercise information such as the total number of steps, the total calorie consumption and the required supplement of nutrition according to the total length of the path and the selected exercise mode, after the user ends an exercise. Thus, the user can know the appropriate exercise path immediately, and whether or not the amount of exercise is sufficient and the supplement of nutrition is required.

(2) A suggested exercise distance for various exercise modes can be provided through the requirement unit and the evaluation unit according to the predetermined calorie to-be-consumed or predetermined weight to-be-reduced, and the path generating unit generates an exercise path with a suggested exercise distance matched with each exercise mode and tailors an appropriate exercise path according to the user's requirements.

(3) The user's related exercise information can be transmitted through the transmission interface unit to a remote fitness trainer or doctor, such that the professionals can know the user's exercise conditions.

### BRIEF DESCRIPTION OF THE INVENTION

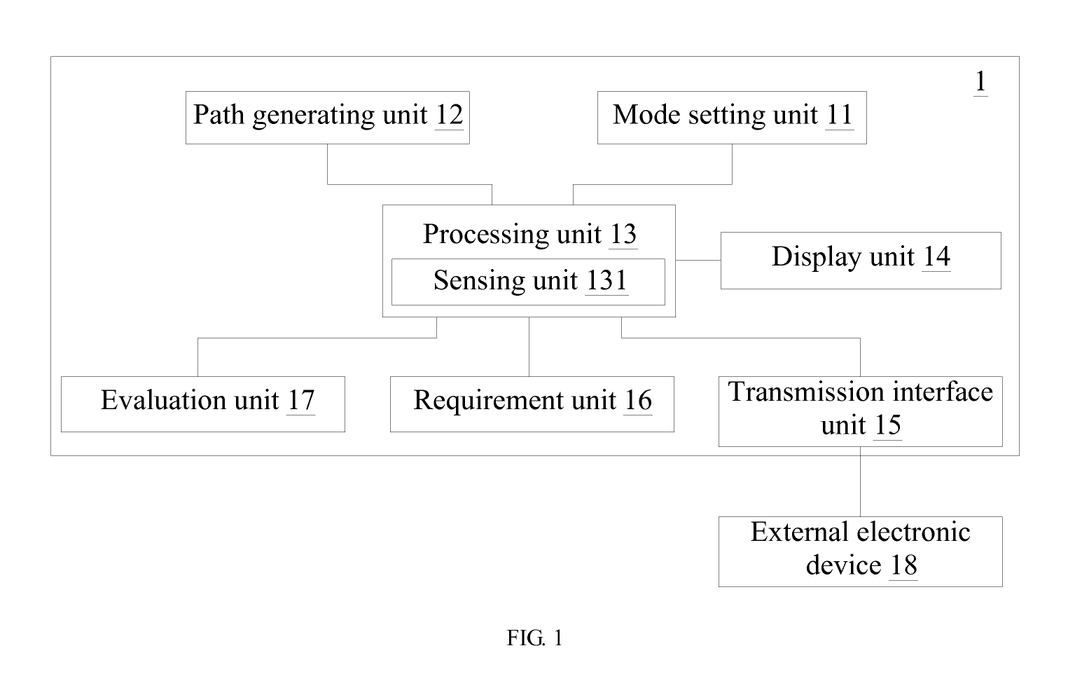

FIG. 1 is a block diagram of a global positioning system pedometer of the present invention;

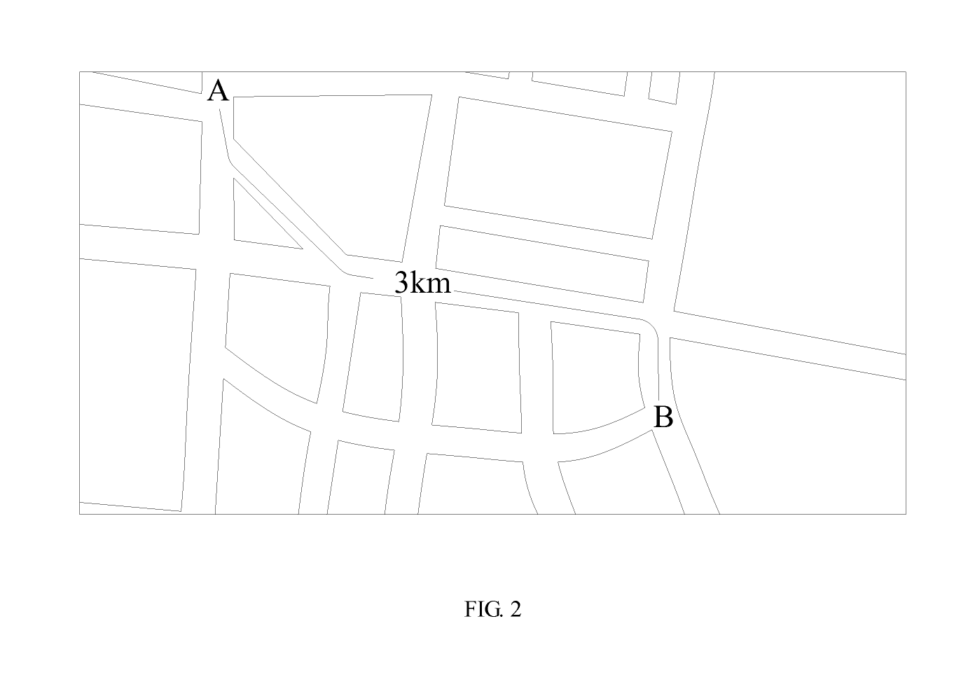

FIG. 2 is a schematic view of a display interface showing an exercise path in accordance with a first preferred embodiment of the present invention;

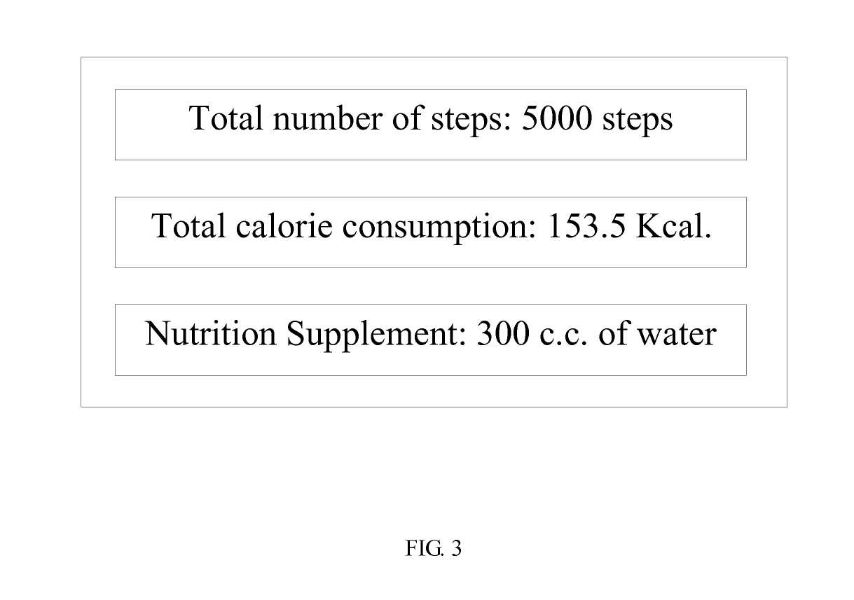

FIG. 3 is a schematic view of a display interface showing user's related exercise information in accordance with the first preferred embodiment of the present invention; and

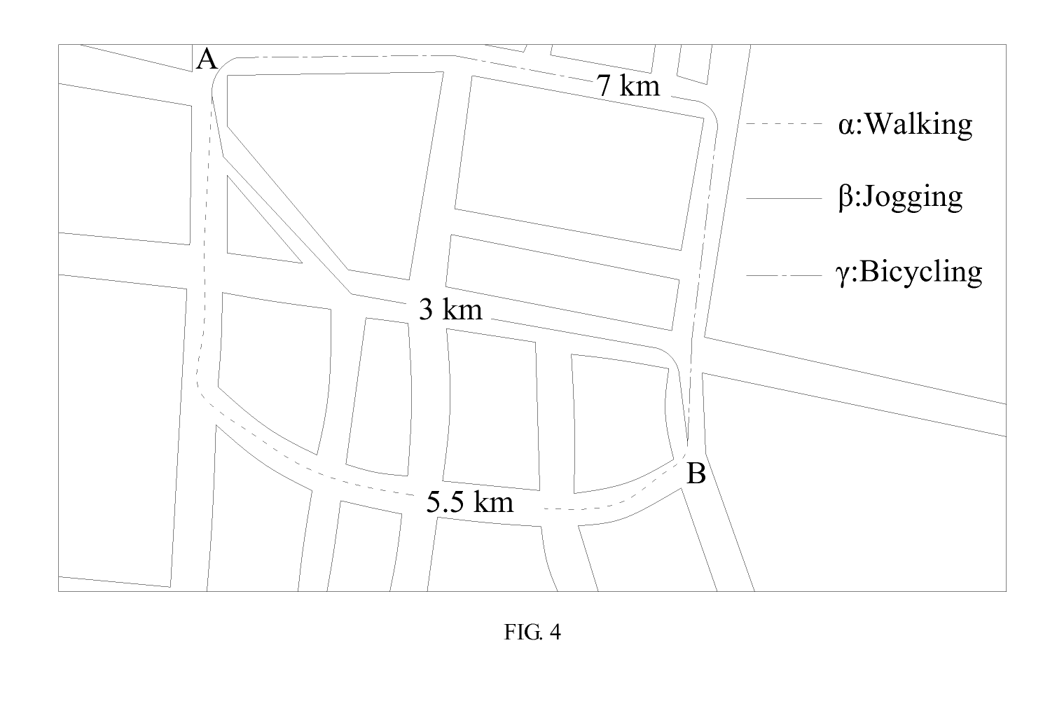

FIG. 4 is a schematic view of a display interface showing an exercise path in accordance with a second preferred embodiment of the present invention.

### DETAILED DESCRIPTION OF THE PREFERRED EMBODIMENTS

The global positioning system pedometer of the present invention will become apparent from the detailed description of the following preferred embodiments and related drawings, and it is noteworthy to point out that same numerals represent respective same elements.

With reference to FIG. 1 for a block diagram of a global positioning system pedometer 1 of the present invention, the global positioning system pedometer 1 comprises a mode setting unit 11, a path generating unit 12, a processing unit 13, a display unit 14, a transmission interface unit 15, a requirement unit 16 and an evaluation unit 17, and the processing unit 13 further comprises a sensing unit 131.

Preferably, the mode setting unit 11 is provided for inputting an exercise mode, and the exercise mode can be walking, jogging, running or bicycling, and the processing unit 13 transmits the inputted exercise mode to the path generating unit 12. The path generating unit 12 provides an exercise path according to a start location and an end location of the exercise and the inputted exercise mode, and then the total distance of the exercise path is calculated according to the provided exercise path. The processing unit 13 transmits the provided exercise path to the display unit 14, and the display unit 14 outputs the exercise path to inform the user about the exercise path. Wherein, the start location and end location of the exercise can be the same location, such as the position of the user's residence that allows the user to return home directly after finishing the exercise.

The sensing unit 131 of the processing unit 13 senses the user's exercise steps to obtain the total current number of steps which the user has done, and then the processing unit 13 further calculates the calorie consumption of the user's exercise according to the total number of steps and the inputted exercise mode and generates nutrition supplement information corresponding to the calorie consumption. Finally, the display unit 14 receives the total number of step, the calorie consumption, and the nutrition supplement information through the processing unit 13 and displays the total number of steps, the calorie consumption and the nutrition supplement information to let the user know about the related exercise data and the required supplement of nutrition.

Through the transmission interface unit 15, the related exercise information, such as the calorie consumption and the total number of steps, can be transmitted to an external electronic device 18 to let a remote fitness trainer or doctor use the external electronic device 18 to understand the user's exercise conditions. Wherein, the transmission interface unit 15 can be a wireless communication transmission module, and the external electronic device 18 can be a digital device, such as a computer.

In addition, the preferred embodiment of the invention further can plan and provide an appropriate exercise path to the user according to the user's requirement. Now, the requirement unit 16 can record the user's exercise requirement information, wherein the exercise requirement information can be predetermined calorie to-be-consumed or predetermined weight to-be-reduced. Through the processing unit 13, the user's exercise requirement information is transmitted to the evaluation unit 17. The evaluation unit 17 provides a suggested exercise distance for various exercise modes according to the user's predetermined calorie to-be-consumed or predetermined weight to-be-reduced. The processing unit 13 transmits the suggested exercise distance of various exercise modes to the path generating unit 12. The path generating unit 12 generates different exercise paths according to the suggested exercise distance, the start location of an exercise and the end location of the exercise at different exercise modes, and each exercise path matches the suggested exercise distance of the exercise mode. The display unit 14 shows the exercise path as a reference for the user.

With reference to FIG. 2 for a schematic view of a display interface showing an exercise path in accordance with a first preferred embodiment of the present invention, when the user sets the exercise mode to walking, and the start location is A and the end location is B, the path generating unit 12 receives the set exercise mode, the start location A and the end location B information through the processing unit 13 to provide an exercise path from A to B as shown in FIG. 2. The path generating unit 12 further calculates the total distance of the exercise path according to the exercise path from A to B and displays the total distance 3 Km on the screen as shown in FIG. 2.

With reference to FIG. 3 for a schematic view of a display interface showing user's related exercise information in accordance with the first preferred embodiment of the present invention, the global positioning system pedometer of the present invention receives the information of the total distance of the exercise path from A to B and the exercise mode of walking through the processing unit 13, and the sensing unit 131 senses the user's exercise steps to obtain the total number of steps of the exercise. The processing unit 13 calculates the user's calorie consumption and nutrition supplement information corresponding to the calorie consumption according to the information of the total number of steps and the exercise mode of walking In FIG. 3, after the user has walked along the path from A to B, the total number of steps equal to 5000, the calorie consumption equal to 153.5 Kcal, and the required supplement of water equal to 300 cc are displayed.

With reference to FIG. 4 for a schematic view of a display interface showing an exercise path in accordance with a second preferred embodiment of the present invention, the user can set the predetermined calorie to-be-consumed to, for example, 250 Kcal through the requirement unit 16. After the evaluation unit 17 receives such information through the processing unit 13, the evaluation unit 17 provides a suggested exercise distance for each exercise mode of walking, jogging and bicycling according to the predetermined calorie consumption of 250 Kcal, and provides the suggested exercise distance for each exercise mode to the path generating unit 12 through the processing unit 13. Finally, the path generating unit 12 generates an exercise path matched with the suggested exercise distance for each exercise mode according to the suggested exercise distance of each exercise mode, the exercise start location A and the exercise end location B.

In FIG. 4, different exercises paths, such as an exercise path α, an exercise path β and an exercise path γ, from an exercise start location A to an exercise end location B are generated according to the suggested exercise distance of each exercise mode. Wherein, the exercise path a matches the suggested exercise distance of 5.5 Km for the exercise mode of walking, the exercise path β matches the suggested exercise distance of 3 Km for the exercise mode of jogging, and the exercise path γ matches the suggested exercise distance of 7 Km for the exercise mode of bicycling, provided that the calorie consumption is expected to be 250 Kcal.

In summation of the description above, the global positioning system pedometer of the present invention allows users to know an appropriate exercise path immediately, whether or not the amount of exercise is sufficient and the supplement of nutrition is required, and tailors an appropriate exercise path according to the user's different requirements. In addition, a transmission interface is used for transmitting the user's exercise related information to a fitness trainer or a doctor to let the professionals to timely control the user's exercise conditions.

While the invention has been described with reference to a preferred embodiment thereof, it is to be understood that modifications or variations may be easily made without departing from the spirit of this invention, which is defined in the appended claims.

What is claimed is:

1. A global positioning system pedometer, comprising:
a mode setting unit for setting an exercise mode;
a path generating unit for generating an exercise path based on a start location, an end location and the exercise mode, and for calculating a total distance of the exercise path;
a processing unit coupled to the mode setting unit and the path generating unit, and comprising a sensing unit for sensing an exercise step of a user to obtain a total number of steps, wherein the processing unit calculates calorie consumption based on the total number of steps and the exercise mode, and generates nutrition supplement information corresponding to the calorie consumption; and
a display unit coupled to the processing unit, for receiving and displaying the exercise path, the total number of steps, the calorie consumption and the nutrition supplement information.

2. The global positioning system pedometer of claim 1, further comprising a positioning unit for obtaining a current location and taking the current location as the start location.

3. The global positioning system pedometer of claim 1, further comprising a transmission interface unit for connecting to an external electronic device, and the global positioning system pedometer transmits the total number of steps, the calorie consumption and the nutrition supplement information to the external electronic device through the transmission interface unit.

4. The global positioning system pedometer of claim 3, wherein the transmission interface unit comprises a wireless Bluetooth module or an infrared transmission module.

5. The global positioning system pedometer of claim 1, wherein the exercise mode is walking, jogging, running or bicycling.

6. The global positioning system pedometer of claim 1, wherein the start location and the end location are the same location.

7. The global positioning system pedometer of claim 1, further comprising:
a requirement unit coupled to the processing unit, for recording exercise requirement information comprising predetermined calorie to-be-consumed or predetermined weight to-be-reduced; and
an evaluation unit coupled to the processing unit, for providing a suggested exercise distance based on the exercise requirement information and the exercise mode.

8. The global positioning system pedometer of claim 7, wherein the path generating unit further generates the exercise path matched with the suggested exercise distance based on the suggested exercise distance, the start location, the end location and the exercise mode.
